(19) United States
(12) Patent Application Publication
(10) Pub. No.: US 2025/0181048 A1
(43) Pub. Date: Jun. 5, 2025

(54) METHOD FOR SELECTING PARTS TO BE PLACED ON SHEETS

(71) Applicant: TRUMPF Werkzeugmaschinen SE + Co. KG, Ditzingen (DE)

(72) Inventors: Kirolos Abdou, Stuttgart (DE); Osama Mohammed, Bietigheim-Bissingen (DE)

(21) Appl. No.: 19/053,456

(22) Filed: Feb. 14, 2025

Related U.S. Application Data
(63) Continuation of application No. PCT/EP2023/070265, filed on Jul. 21, 2023.

(30) Foreign Application Priority Data
Aug. 15, 2022 (DE) 10 2022 120 516.9
Nov. 17, 2022 (DE) 10 2022 130 459.0

(51) Int. Cl. G05B 19/042

(52) U.S. Cl. CPC G05B 19/0426

(57) ABSTRACT

A method for selecting parts to be placed on sheets includes encoding geometric features of each part in a respective geometric information vector, generating a graph in which the geometric features of each part are assigned to one node of the graph, estimating geometrical compatibility indices (GCI) for all pairs of parts, assigning each GCI to a respective edge of the graph, which passes through two nodes representing the pair of parts, determining weights of the edges of the graph depending on the GCI associated with the edges, and assigning the parts to a respective sheet by determining subgraphs through the nodes of the graph by an optimization method. The nodes through which a respective subgraph passes represent the parts to be placed on the respective sheet. A sum of the projected areas of the parts on each subgraph is at most equal to a size of the respective sheet.

### CROSS REFERENCE TO RELATED APPLICATIONS

This application is a continuation of International Application No. PCT/EP2023/070265 (WO 2024/037825), filed on Jul. 21, 2023, and claims benefit to German Patent Application No. DE 10 2022 130 459.0, filed on Nov. 17, 2022 and to German Patent Application No. DE 10 2022 120 516.9, filed on Aug. 15, 2022. The aforementioned applications are hereby incorporated by reference herein.

### FIELD

Embodiments of the present invention relate to a method for selecting parts to be placed on sheets using a computer.

### BACKGROUND

DE 10 2020 129 293 A1 discloses a method for generating a cutting plan for cutting out parts from a plate-shaped material sheet. In particular, a plan for nesting the parts is generated in order to keep material waste to a minimum.

However, the method does not allow for flexible selection of parts to reduce the amount of material waste that occurs when cutting parts from a sheet.

### SUMMARY

Embodiments of the present invention provide a method for selecting parts to be placed on sheets using a computer. The method includes encoding geometric features of each part in a respective geometric information vector. For each part, one of the geometric features is a projected area of the part in a plan view. The method further includes generating a graph. The geometric features of each part are assigned to one node of the graph. All nodes of the graph are connected in pairs by one edge. The method further includes, in an inference phase, estimating geometrical compatibility indices (GCI) for all pairs of parts, wherein each GCI is a measure of how well the respective pair of parts is capable of being placed on a same sheet, assigning each GCI to a respective edge of the graph, the respective edge passing through two nodes representing the pair of parts to which the respective GCI is assigned, determining weights of the edges of the graph, wherein the respective weight of each respective edge depends on the GCI associated with the respective edge, and assigning the parts to a respective sheet by determining subgraphs through the nodes of the graph by an optimization method. The nodes through which a respective subgraph passes represent the parts to be placed on the respective sheet. A sum of the projected areas of the parts on each subgraph is at most equal to a size of the respective sheet.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows an example of geometrically compatible parts according to some embodiments;

FIG. 1b shows an example of geometrically incompatible parts according to some embodiments;

FIG. 2a schematically shows a sheet before nesting of parts;

FIG. 2b schematically shows a sheet wherein an additional triangular part is nested with the parts shown in FIG. 2a according to some embodiments;

FIG. 2c schematically shows the nesting of two circular parts with the parts shown in FIG. 2a according to some embodiments;

FIG. 3 schematically shows an overview of the method according to some embodiments;

FIG. 4a shows a rasterized image of a single part, wherein the geometrical shape of the part is encoded by an autoencoder, according to some embodiments;

FIG. 4b shows a rasterized image of a layout of several parts, wherein the geometrical shape of each part is encoded by an autoencoder, according to some embodiments;

FIG. 5 schematically shows an actor-like and a critic-like module used in the method according to some embodiments;

FIG. 6 schematically shows a block diagram for a data collection and an update step in a learning routine according to some embodiments;

FIG. 7a schematically shows an example of a capacitated vehicle routing problem (CVRP) according to some embodiments;

FIG. 7b schematically shows a geometrical relationship graph (GRG) used in the method according to some embodiments;

FIG. 8 schematically shows an example of large GRGs and subgraphs of the GRGs according to some embodiments;

FIG. 9a shows a first example of an edge weight loss using a first model for testing the method according to some embodiments;

FIG. 9b shows a first example of a reward loss using the first model for testing the method according to some embodiments;

FIG. 10a shows a second example an edge weight loss using a second model for testing the method according to some embodiments;

FIG. 10b shows a second example of a reward loss using the second model for testing the method according to some embodiments;

FIG. 11a shows a part from an example dataset for testing the method according to some embodiments before a preprocessing step;

FIG. 11b shows a part from an example dataset for testing the method according to some embodiments after a preprocessing step;

FIG. 12a shows a visualization of parameters GCI using the first model for testing the method according to some embodiments for a first set of parts;

FIG. 12b shows a visualization of parameters GCI using the second model for testing the method according to some embodiments for the first set of parts;

FIG. 12c shows a visualization of parameters GCI using the first model for testing the method according to some embodiments for a second set of parts;

FIG. 12d shows a visualization of parameters GCI using the second model for testing the method according to some embodiments for the second set of parts;

FIG. 13a shows the nesting of parts with regular shapes using a nesting software.

FIG. 13b shows the nesting of 500 parts with regular shapes using the first model for testing the method according to some embodiments;

FIG. 13c shows the nesting of 2000 parts with regular shapes using the first model for testing the method according to some embodiments;

FIG. 13d shows the nesting of 500 parts with regular shapes using the second model for testing the method according to some embodiments;

FIG. 13e shows the nesting of 2000 parts with regular shapes using the second model for testing the method according to some embodiments;

FIG. 14a shows the nesting of parts with irregular shapes using the nesting software.

FIG. 14b shows the nesting of 500 parts with irregular shapes using the first model for testing the method according to some embodiments;

FIG. 14c shows the nesting of 2000 parts with irregular shapes using the first model for testing the method according to some embodiments;

FIG. 14d shows the nesting of 500 parts with irregular shapes using the second model for testing the method according to some embodiments;

FIG. 14e shows the nesting of 2000 parts with irregular shapes using the second model for testing the method according to some embodiments; and

FIG. 15 schematically shows the process of determining the GCI for all pairs of the parts in a training phase of the method according to some embodiments for selecting parts to be placed on sheets.

### DETAILED DESCRIPTION

Embodiments of the invention provide a method for assigning parts to metal sheets in a way that minimizes the material waste that occurs when the parts are cut from the metal sheets.

The method according to embodiments of the invention comprises the following steps:
I. Encoding the geometric features of each part in a respective geometric information vector, where for each part one of the geometric features is the projected area of the part in plan view;
II. Generating a graph, where the geometric features of each part are assigned to one node of the graph at a time, where all nodes are connected in pairs by one edge at a time,
   wherein the method includes the following further steps in an inference phase:
XIV. Estimating parameters GCI (Geometrical compatibility index/indices) for all pairs of parts, where each GCI is a measure of how well that pair of parts can be placed on the same sheet;
XV. Assigning each GCI to a respective edge of the graph, the respective edge passing through the two nodes representing the parts to which the respective GCI is assigned;
XVI. Determining the weights of the edges of the graph, where each edge weight depends on the GCI associated with the edge;
XVII. Assigning the parts to a respective sheet by determining subgraphs through the nodes of the graph by an optimization method, wherein the nodes through which a respective subgraph passes represent the parts to be placed on a sheet, wherein the sum of the projected areas of the parts on each subgraph is at most equal to the respective sheet size.

According to embodiments of the invention, a set of parts is divided into subsets, each subset being arranged on a respective sheet. The subsets are determined such that the parts of the subsets optimally cover the respective sheets. The selection of suitable parts for a respective sheet simplifies the subsequent arrangement of the parts on the sheet. In particular, methods for determining the arrangement of parts on a particular sheet can be applied to a comparatively small number of parts previously determined for the sheet in question. Furthermore, material losses during cutting of the parts are greatly reduced.

The geometric information vector contains information on the shape and size of the respective part, for example, data on angles between edges of the part, side lengths of the part, and curvatures of the part.

The relationship between the weight w of a respective edge of the graph and the GCI assigned to the edge according to step XVI is given in particular by: w=1−GCI.

The graph is preferably designed as a fully connected geometrical relationship graph.

In an advantageous embodiment of the method, the optimization method in step XVII is performed using a quantum computer. In particular, a qubit can be assigned to each node of the graph. Thus, advantageously, high computational power of a quantum computer can be used while keeping the number of qubits required comparatively low.

In some embodiments of the method, one or more steps of the method are performed by a first neural network, preferably a Graph Neural Network, particularly preferably a Graph Convolutional Neural Network. The geometric information vectors associated with the parts are represented as nodes of the graph. Graph Neural Networks are then particularly useful for classifying the nodes according to which sheet the parts belong to that are represented by the nodes.

In preferred embodiments of the method, steps XIV, XV and/or XVI are performed by an actor-like module, wherein the actor-like module preferably comprises the first neural network. The actor-like module can be trained by the method of reinforcement learning to learn a strategy comparatively quickly, with which differently shaped parts can be assigned to given sheets in an optimal way.

In an advantageous variant of the method, assigning the parts to a respective sheet according to step XVII is performed by an optimization method for solving the capacitated vehicle routing problem (CVRP). The optimization procedure for solving the CVRP enables an optimal assignment of the parts to the respective sheets to be determined in a comparatively short time. In particular, the weights of the edges correspond to the distances between locations in the CVRP. The areas of the parts in plan view encoded in the nodes of the graph correspond to the capacities or demands assigned to the individual locations in the CVRP. The sheets on which the parts are placed correspond to the vehicles in the CVRP.

In particular, an algorithm for solving the CVRP can be implemented on a quantum computer to group the nodes of the graph into subsets, where the nodes in each subset correspond to the parts on a respective sheet.

According to a preferred embodiment of the method, the sheets have the same sheet size. This simplifies the application of a method for solving the CVRP in order find the optimal assignment of given parts to respective sheets.

In an advantageous embodiment of the method, determining the GCI for all pairs of the parts in a training phase which is performed before the inference phase comprises the following steps:
III. Setting estimated values of the GCI, where each estimated value of the GCI is assigned to a pair of the parts respectively;
IV. Providing the edges of the graph with first edge weights, where each first edge weight depends on the respective GCI assigned to the edge;
V. Assigning the parts to a respective sheet by determining subgraphs through the nodes of the graph according to step XVII;
VI. Determining a reward function value for each subgraph as a measure of how much of the surface area of the respective sheet is covered by the parts on each subgraph after the parts are nested on the respective sheet;
VII. Determining a suitability value for each subgraph in the form of an average of output values for the respective subgraph, where the output values take into account the estimated values of the GCI, wherein the average is determined by taking into account all the output values for the respective subgraph;
VIII. Redetermining the GCI on each subgraph such that a reward loss is reduced on each subgraph, where the reward loss depends on the reward function value and the suitability value;
IX. Repeating steps VI through VIII until the reward loss meets a first termination criterion;
X. Estimating second edge weights of the edges of the graph, in particular by steps XIV to XVI;
XI. Determining edge weight losses at the edges of the graph, wherein the edge weight losses depend on the second edge weights and the GCI determined in step VIII at the respective edges;
XII. Repeating steps X and XI, wherein estimating the second edge weights is performed such that the edge weight losses are minimized until the edge weight losses meet a second termination criterion;
XIII. Repeating steps III through XII, wherein the estimated values of the GCI in step III are set to be the second edge weights last determined in step XII until the estimated values of the GCI meet a third termination criterion.

In this embodiment, the estimation method for estimating the second edge weights is advantageously optimized in the training phase to find suitable values of the GCI for given parts in as few steps as possible.

In particular, the relationship between a first weight w of a respective edge and the GCI associated with the edge is given by: w=1−GCI. The same applies to the second weights of the edges. The average according to step VII is determined in particular as an arithmetic mean value. The reward loss according to step VIII is in particular calculated by a Laplacian loss function L₁, which depends on the reward function value and the suitability value.

The reward function value according to step VI can for example be calculated as the ratio of the sum of the projected areas of the parts in plan view to the respective sheet size for cach subgraph.

Preferably, the output values according to step VII are determined by passing the nodes of a respective subgraph through a first and a second consecutive graph convolutional neural network (GCNConv) layer, wherein the GCNConv layers initially use estimated values of the GCI as inputs, for example the estimated values from step III. The output of the first GCNConv layer is provided as input to the second GCNConv layer by a message passing function which takes into account the estimated values of the GCIs, the number of edges connected to each node in the subgraph, an information on which nodes are connected together, the weighted geometric information encoded in the nodes by the geometric information vectors and/or trainable weights of the GCNConv layers. The output values of the second GCNConv layer are then used to determine the average according to step VII.

In some embodiments of the method, steps X, XI and/or XII are performed by the actor-like module. The training procedure, in particular steps X, XI and/or XII, trains the actor-like module in such a way that advantageously the actor-like module alone can find the GCI when presented with new parts without further input.

In advantageous variants of the method, the step III, IV, VII, VIII and/or IX is/are performed by a critic-like module, wherein the critic-like module in particular comprises a second neural network, wherein the critic-like module preferably comprises a third neural network in addition to the second neural network, wherein the third neural network receives result data of the second neural network. The critic-like module can be used to improve the actor-like module without any external (human) input in the training phase by specifying values for the GCI parameters to be achieved by the actor-like module. By using two layers of the crtic-like module, the effort to determine the GCI can be reduced. For this purpose, the layers are designed in particular as convolutional layers.

In particular, all the output data of the critc-like module, preferably of the third neural network belonging to the critic-like module, is averaged to a single value corresponding to the suitability value in step VII.

The edge weight losses according to step X are preferably determined by a loss function, preferably a Gaussian loss function L₂, which depends on the second edge weights (the values of the GCI determined by the actor-like module) and the first edge weights (the values of the edge weights determined by the critic-like module).

According to an advantageous embodiment of the method, the redetermination of the GCI according to step VIII is performed using error backpropagation to minimize the reward loss for the respective subgraph. The backpropagation allows the GCI to be determined in a comparatively time-saving manner according to step VIII in such a way that the reward loss function is minimized. The backpropagation is in particular used in connection with the Laplacian loss function L₁ mentioned above.

In some variants of the method, the first termination criterion according to step IX is given by the reward loss being smaller than a first default value and/or the second termination criterion according to step XII is given by the edge weight losses at the edges of the graph being smaller than a second default value and/or the third termination criterion according to step XIII is given by the estimated values of the GCI changing by less than a third default value after going through steps III to XII. In particular, each individual edge weight loss is smaller than the second default value. Preferably, the change in each individual estimated value of the GCI is less than the third default value.

In a further embodiment of the method, the GCI are determined in step XIV using a metaheuristic. A metaheuristic can be used to determine approximate values of the GCI to obtain comparative values for the GCI obtained by a method according to steps XV through XVII. A metaheuristic can also be used if the values of the GCI cannot be found by a method according to steps XV through XVII.

In an advantageous variant of the method, the parts are arranged on the sheets and subsequently produced. If parts are manufactured using this method, material waste is greatly reduced during the production of the parts.

Exemplary embodiments are described below with reference to the drawing. The above-mentioned and the still further elaborated features can each be used individually or in any combination. The embodiments shown and described are not to be understood as a conclusive list, but rather have an exemplary character.

Reducing the material waste and operating time are primary objectives in Cutting and Packing problems (C&P). A solution to the C&P problem consists of many steps, including the grouping of items to be nested and the arrangement of clustered items on a large object. Current algorithms use meta-heuristics to solve the arrangement problem directly without explicitly addressing the grouping problem. In this work, we propose a new pipeline for the nesting problem that starts with grouping the items to be nested then arranging them on large objects. To this end, we introduce and motivate a new concept, namely the Geometrical Compatibility Index (GCI). Items with higher GCI should be clustered together. Since estimating GCIs is an unsupervised problem, we propose a Reinforcement Learning-based framework, which consists of two Graph Neural Networks (GNNs) trained in an actor-critic-like fashion. To group the items into clusters, we model the estimated GCIs in a graph as the reciprocal of distance in a Capacitated Vehicle Routing Problem (CVRP) and solve it using meta-heuristics. Experiments conducted on a private dataset with regularly and irregularly shaped parts show that the proposed algorithm can achieve a significant reduction in operating time (34% to 50%) compared to an open-source nesting software while attaining similar trim loss on regular parts and a three-fold improvement in trim loss on irregular parts.

### I. INTRODUCTION

The cutting and packing problems (in short C&P problems) are related to many areas of the operations research (OP) and they have been extensively studied for decades. The C&P problems have been referred to, in literature, with different terminologies over the past decades [1]-[3].

The C&P are NP-hard problems with identical common logical structure which can be described as follows. The inputs are two groups of geometrical data elements, namely a set of large objects, and a set of small items. The aim is then to select a set of some or all small items, group them into one or more subsets, and finally pack each of the resulting subsets on a corresponding large object, in a pattern (a.k.a. layout), while satisfying some geometric conditions [4]. The first geometric condition to be satisfied is that the small items of each subset must be laid entirely within the sheet. And the second geometric condition is that all small items lying on the same large object must not overlap. The residual unused areas, remaining uncovered by a small item, on the layout are usually treated as trim loss or waste. The objectives of the C&P problem are to reduce this waste to maximize the material utilization and to reduce the operating time. Reducing the trim loss can be very beneficial from the economic point of view in very large scale productions such as sheet metal, wood and textile production as it can result in savings of material and consequently in reduction of production costs.

In general, a solution to a C&P problem may consist of using a set of some or all large objects, and a set of some or all small items depending on the problem's objective and constraints. Considering the broad constraints, a formal formulation of five sub-problems can be derived [3]:
1) Large Object selection problem: selecting the large objects on which the small items should be packed or cut
2) Small items selection problem: selecting the small items to be packed or cut
3) Grouping problem: grouping the selected small items into subsets
4) Allocation problem: assigning the subsets of the small items to the large objects
5) Layout problem: arranging the small items on each of the selected large objects, by first finding the order of the small items and then by placing them on the large object with respect to the geometric conditions.

In almost all of the C&P industries, the small items to be packed are provided by customers and hence the second sub-problem is disregarded. If similar large objects are used, which is usually the case, the first and fourth sub-problems will be dropped. Therefore, the C&P problem is practically reduced to only the third and fifth sub-problems, i.e., grouping the parts to be nested into clusters and finding a layout for each cluster by arranging its small items on a large object.

In most of the C&P industries, the C&P process is referred to by the Nesting process. The small items are also usually called Parts and the large objects are called Sheets. The latter terms, i.e., nesting, parts, and sheets, will be henceforth used in this work.

Over the past decades, the fifth sub-problem, i.e., the “layout problem”, has been mostly addressed, where it is assumed that only one sheet is used for all of the parts and hence no parts clustering is needed. The layout problem has been extensively studied using exact methods [5]-[9], heuristics [10]-[14], meta-heuristics [15]-[18], supervised machine learning [19], [20], and reinforcement learning [21]-[26]. In contrast, the third sub-problem, i.e., the “grouping problem”, has often been ignored. The current existing commercial nesting software known to us solve the grouping problem implicitly as a part of the layout problem. They start with a single sheet for placing all the parts then discard the parts that do not fit on the current sheet and place them on a new one.

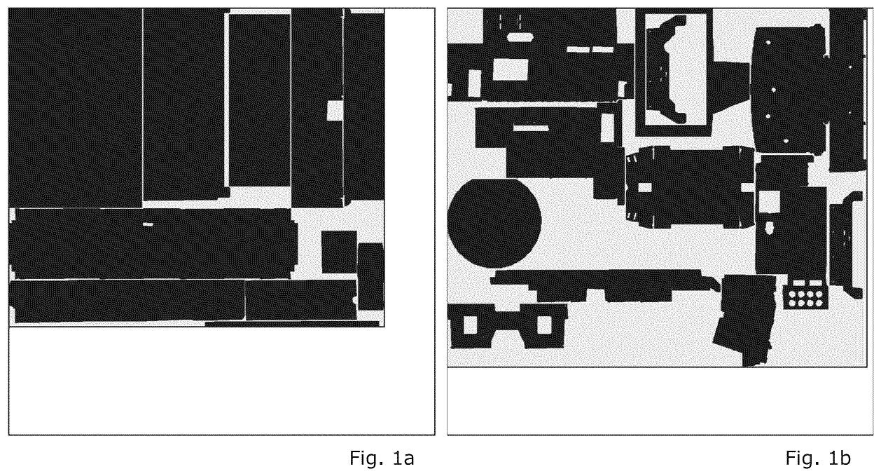

In this work, we hypothesize that a new nesting pipeline, where the grouping problem is directly solved before the layout problem, will positively impact both material utilization and the nesting time. We reason that the trim loss can be reduced if the clustered parts already fit together geometrically before placing them on the sheet (FIG. 1). This in turn will reduce the nesting time as meta-heuristics will be applied to a smaller number of parts per cluster. Therefore, in this work, we suggest solving the grouping problem explicitly with a learning-based approach. The layout problem will be addressed in a follow-up work and is out-of-scope of this work.

To the best of our knowledge, this is the first learning-based approach for solving the grouping problem in the scope of nesting. The grouping problem is an unsupervised learning task, as we initially do not have any labels or hints about the geometrical suitability between the parts to be nested. We quantize, in this work, the parts' geometrical suitability by a value which we call the “Geometrical Compatibility Index” (GCI). We model the GCI as the weights of the edges of a fully connected Geometrical Relationship Graph (GRG) by means of a Graph Neural Network (GNN). The targets used to update the GNN parameters are generated using meta-heuristics in a Reinforcement Learning (RL) fashion.

The flow of this work is as follows. A practical motivation for the geometrical compatibility concept and its effect on trim loss is provided in Section III. Our definitions and hypotheses about the geometrical compatibility concept are then introduced in Section IV. In Section V, we present current research state relating to estimating the edges in a GNN and how they relate to our work, we also show some paradigms that will be used later in our methodology. In Section VI, we show an example of our dataset and reveal the preprocessing applied on it. We explain also in details the architecture of our framework for estimating the GCI values for a set of given parts. We conduct a study on the effect of different non-linear reward functions on our framework and discuss their results in Section VII-A. In Section VII-B, we compare the performance of our framework against an existing open-source nesting software. Finally we conclude our work in Section VIII and suggest further future research directions.

According to some embodiments,
1) We propose a new pipeline for nesting, which begins by solving the grouping problem before the layout problem.
2) We define two new concepts, namely the GRG and GCI, which will enable to solve the grouping problem.
3) To estimate the GCI, we propose a novel RL-based framework which deploys two GNNs in an actor-critic-like fashion.
4) We suggest to group the parts based on the GCI by solving the GRG as a Capacitated Vehicle Routing Problem (CVRP) using meta-heursitics.
5) We demonstrate that our model can train on more than 2, 000 parts with irregular shapes. We report results on two test splits from a private dataset from real-world sheet metal production. Results show that our best model can achieve a considerable improvement (34% to 50%) in operating time, a 70% reduction in waste material on one test split, and a comparable trim loss on the other test split.

### II. PROBLEM FORMULATION

In this section, we formally define the grouping problem. We assume there are N parts to be nested on K sheets. We denote the parts areas by aₙ, their geometry information by gₙ and the sheets' areas by s_{K}. In this formulation, the geometry information encodes the inner and outer contours of each part. In this work, we consider that gₙ is a vector in latent space, R^{d}, where d is the dimension of the latent space. We seek to find xₙ^{k}∈{0,1}, which denotes whether the part n will be assigned to sheet k. Parts which are assigned to the same sheet are grouped together. The optimization problem can be formulated as follows:

$$arg min \text{?} {\sum }_{k = 1}^{κ} [ Area ( {BB}_{k} ) - {\sum }_{n = 1}^{N} {x}_{n}^{k} {a}_{n} ] \qquad ( 1 a )$$

$$s . t . {\sum }_{k = 1}^{K} {x}_{n}^{k} = 1 , ∀ n ∈ \{ 1 , … N \} \qquad ( 1 b )$$

$${\sum }^{N} \text{?} {x}_{n}^{k} {a}_{n} \leq \text{?} , ∀ k ∈ \{ 1 , … , K \} \qquad ( 1 c )$$

$${\sum }^{𝒩} \text{?} {x}_{n}^{k} {a}_{n} + ( 1 - {x}_{m}^{k} ) {a}_{m} > \text{?} ,$$

$$∀ m ∈ \{ 1 , … , N \}$$

$$∋ {x}_{n}^{k} = 0 ∀ k ∈ \{ 1 , … , K \} \qquad ( 1 d )$$

$$\text{?} \text{indicates text missing or illegible when filed}$$

BBₖ is the rectangular bounding box enclosing all the parts nested on sheet k. BBₖ is first calculated by solving the layout problem for sheet k, i.e., after nesting all parts which have xₙ^{k}=1 on sheet k. Equation (1a) denotes finding xₙ^{k} which minimizes the material waste, Area(BBₖ)−Σₙ₌₁^{N}aₙ on each sheet. The constraint in (1b) states that each part must be assigned to one and only one sheet. The second constraint in (1c) states that the total area of all nested parts on sheet k must not exceed the sheet's area, sₖ. And the final constraint in (1d) imposes that each sheet must be used to its maximum capacity.

This optimization problem is ill-defined because Area (BBk) is an unknown non-linear function of the nested parts' geometry and areas. It can be expressed as:

$$Area ( {BB}_{k} ) = ℱ ( {g}_{1} {x}_{1}^{k} , {g}_{2} {x}_{2}^{k} , … , {g}_{N} {x}_{N}^{k} , {a}_{1} {x}_{1}^{k} , {a}_{2} {x}_{2}^{k} , … , {a}_{N} {x}_{N}^{k} ) \qquad ( 2 )$$

A solution to the grouping problem consists in finding a mapping function π, which maps the parts' geometrical information gₙ, parts' areas aₙ, and the sheets areas sx to the coefficients xₙ^{k}, which determine the groups.

### III. MOTIVATION TO THE PROPOSED APPROACH

To find a solution to the grouping problem, we seek to approximate the mapping:

$$π : {\{ {a}_{n} , {a}_{n} \}}_{n = 1}^{N} ⋃ {\{ {s}_{k} \}}_{k = 1}^{K} ↦ {\{ {x}_{n}^{k} \}}_{k , n = 1}^{K , N} . \qquad ( 3 )$$

Since this mapping is hard to estimate, we propose to break it down into two mappings by introducing an intermediary value which can be learned from the data and can then act as a criteria for the grouping. For the intermediary value, we define a new concept, the Geometrical Compatibility Index (GCI). The mapping I can be expressed as π=π₂∘π₁. The first function in the proposed solution, π₁, tries to estimate the GCIs between all the parts given their geometrical information, {gₙ}ₙ₌₁^{N}. The set of all estimated GCIs is expressed as {GCI_{n,m}}, where n and m are two different parts. The second function, π₂, estimates the coefficients {xₙ^{k}} given the GCIs. For instance, parts with high GCIs should be grouped together, while parts which have low GCIs should belong to different groups. In short, the mapping functions can be expressed as:

$${π}_{2} \text{?} {π}_{1} : {\{ {a}_{n} , {g}_{n} \}}_{n = 1}^{N} ⋃ {\{ {s}_{k} \}}_{k = 1}^{K} ↦ {\{ {x}_{n}^{k} \}}_{k , n = 1}^{K , N} \qquad ( 4 a )$$

$${π}_{1} : {\{ {g}_{n} \}}_{n = 1}^{N} ↦ {\{ {GCI}_{n , m} \}}_{n , m = 1}^{N , N} \qquad ( 4 b )$$

$${π}_{2} : {\{ {GCI}_{n , m} \}}_{n , m = 1}^{N , N} ⋃ {\{ {a}_{n} \}}_{n = 1}^{N} ⋃ {\{ {s}_{k} \}}_{k = 1}^{K} ↦ {\{ {x}_{n}^{k} \}}_{k , n = 1}^{K , N} \qquad ( 4 c )$$

$$\text{?} \text{indicates text missing or illegible when filed}$$

In the following two subsections, we motivate the proposed solution to estimate the mapping functions, π₁ and π₂.

### A. Mapping from Parts to GCIs

The goal of this mapping function π1 is to estimate a quantitative criteria to cluster the parts. We hypothesize that geometrical compatibility between parts is a reasonable choice for the grouping criteria. However, GCI is an abstract concept which we motivate by a simple example, before giving a formal definition in Section IV.

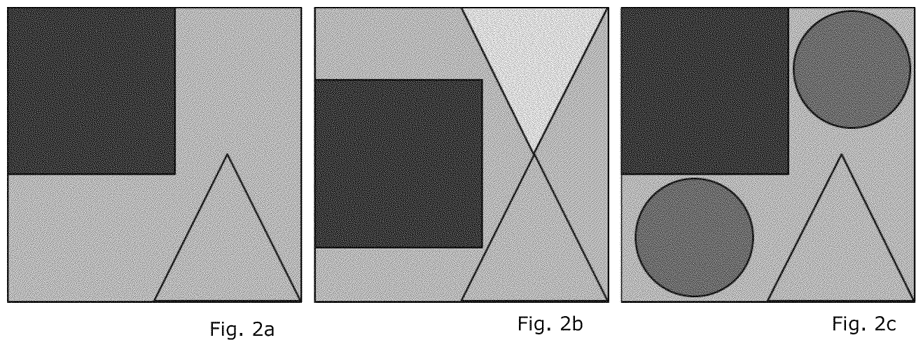

To show how the selection of geometrically compatible parts can lead to more material savings, we show three different simple parts (square, triangle, and circle) in FIG. 2. In the example, we used the grey canvas to represent a square sheet of area 22, 500 mm², on which we want to nest the parts. We also assume two previously nested parts (FIG. 2(a)) shown in green and blue with 2, 812.5 mm², and 7, 225 mm² areas, respectively. The resulting free area of the sheet is then 12, 462.5 mm², which theoretically is more than sufficient to nest another two orange triangular parts with the same dimensions as the green one. By trying to nest two new orange triangles, it becomes obvious that a single one would not fit on the sheet with this layout. The only option that would allow to place a new orange triangle is to change the layout by moving the blue square a bit down (FIG. 2(b)). This, however, also prevents the placement of a second orange triangle, albeit the fact that theoretically the available area on the grey sheet is still enough to accommodate it. On the other hand, a red circle with radius 30 mm and an area of 2, 827.43 mm², i.e., same area as the green and orange triangles, would fit perfectly on the sheet without even changing the layout. Furthermore, it leaves room for a second red circle to be nested (FIG. 2(c)). Consequently, we would say that the orange triangle is geometrically less compatible with the blue square and the green triangle than the red circle.

The red circle instead has a higher geometric compatibility with the nested parts and therefore left more space for another red circle. This subsequently has increased the area utilization and reduced the material waste. Quantitatively, the wasted area for nesting only a single orange triangle is 9, 650 mm², while the wasted are for nesting two red circles is 6, 807.6 mm². Hence, a higher geometrical compatibility saves more area for new parts to be nested and reduces trim loss. Note that the geometrical compatibility is not to be confused with the area suitability. The red circle and orange triangle have the same area, the former is geometrical compatible whilst the second is not. Furthermore, differently sized circles with area less than or equal 3, 257.32 mm², would also fit perfectly without changing the layout.

As shown in the example above, the GCI estimation problem cannot be just estimated in a pairwise manner, without observing other parts in a group. For this, we first assume that all given parts form one large group. To estimate GCIs between all parts, we choose to model the parts as nodes in a graph and GCIs as weighted edges between the nodes. We refer to this graph as the Geometrical Relationship Graph (GRG), and we use a Graph Neural Network (GNN) to estimate the weights of its edges.

### B. Mapping from GCIs to Groups

After estimating the GCIs, we propose to use them as a criteria for the grouping. The mapping π2 can be seen as a solution to another optimization problem, which seeks to find out what are the optimal sets of parts which should be chosen together to achieve the maximum GCI sum for different sheets. This optimization problem can be expressed as:

$$arg {min}_{GCI} {\sum }_{k = 1}^{K} {\sum }_{m = 1}^{M} {\sum }_{n = 1}^{N} ( 1 − GC {I}_{n , m} ) {x}_{n}^{k} {x}_{m}^{k} \qquad ( 5 )$$

This new formulation, while satisfying the constraints in (1b)-(1d), is analogous to a typical Capacitated Vehicle Routing Problem (CVRP) formulation, which tries to find out the optimal set of routes for a fleet of vehicles to traverse. In this analogy, the GCI is the reciprocal of the distance (distance=1−GCI), the sheets are the vehicles with defined capacities (areas) and the parts are the cities in the typical CVRP problem. To solve for π₂, we use meta-heuristics instead of exact methods to find a good solution in an acceptable time.

### C. Learning Paradigm

From Subsection III-A, it is clear that the GCI cannot be concretely estimated in a defined way before solving the layout problem. Moreover, it is not possible to get labels for the GCIs, because the GCIs between parts change whenever the grouping policy changes. It is also very computationally expensive to use a brute-force approach and try out all grouping permutations to generate GCI labels for supervised learning. For this, we propose to learn the GCIs by maximizing a reward function from a nesting environment using Reinforcement Learning (RL). The reward function R is chosen to be the ratio between the area of the parts of a group and the area of the sheet k on which they are nested, and it is computed for each group of parts as follows:

$${ℛ}_{k} = \frac{{\sum }_{n = 1}^{N} {x}_{n}^{k} {a}_{n}}{Area ( {BB}_{k} )} \qquad ( 6 )$$

### IV. DEFINITIONS: GRG & GCI

In this section, we give formal definitions for GCI and GRG.

Definition 1 (GRG). The GRG is a fully connected, bidirectional weighted graph representing the parts to be nested along with their geometrical relationships.
Graph: GRG depicts the parts to be nested as nodes/vertices in the space, and their geometrical relationships as the edges connecting them. GRG has nodes vₙ∈V={v₁, . . . , vₙ} where each node is represented by a geometrical information vector gₙE R_{d}.
Fully connected weighted graph: To outline all of the geometrical relationships between the parts, all the nodes of the GRG are connected to each other and to itself by an edge eₙₘ∈E∀vₙ, vₘ∈V. GRG defines the affinity of the geometrical relationship between two parts vₙ and vₘ by a weight wₙₘ∈[0,1] assigned to their connecting edge eₙₘ.
Bidirectional graph: In the example of Subsection III-A, nesting the triangular part (green) before the square part had a high geometrical compatibility however nesting the triangular part (orange) after the square part had a low geometrical compatibility. This means that the order of nesting the parts affects their geometrical suitability which is represented by directed edges between nodes in the GRG, i.e., wₙₘ≠wₘₙ.

Definition 2 (GCI).: The GCI is a scalar variable with fixed bounds that is computed graph-wise rather than pair-wise. Its value is the weight wₙₘ of the edge eₙₘ in the GRG, i.e., wₙₘ=GCIₙₘ [symbol] GCIₙₘ∈[0,1]. It denotes the geometrical relationship between two parts in the sense of their geometrical compatibility, not their area compatibility, to be nested together on the same sheet.
Scalar variable with fixed bounds: To have a concrete view of the substantial effect of the GCI on nesting, the GCI is designed to be a scalar value ranging from 0 to 1. A GCI of 0 means no geometrical compatibility whilst a GCI of 1 is the highest compatibility index.
Computed graph-wise rather than pair-wise: The GCI cannot be determined by geometrically evaluating the fitness of each pair of parts together (the green triangle looks compatible with the blue square in FIG. 2(a) but the orange triangle is barely compatible with same rectangle in FIG. 2(b)), but rather by nesting all the parts of the GRG graph/sub-graph on a sheet and evaluating the resulting layout. Since there is no explicit calculation method for the GCI, it is instead inferred via machine learning.
Denotes geometrical compatibility not area compatibility: Two different nodes that are area-wise compatible with a third node, i.e., their sum of areas would fit on a sheet, in the GRG do not necessarily have to have the same GCI with this node. This is the case of the orange triangle and the red circle and their compatibility with the blue square in FIG. 2.

### V. RELATED WORKS

### A. Cutting and Packing

Cutting and Packing Problem. The C&P problems exist in various industries and have been studied in depth for a long time [27]. They appear repeatedly in the literature with several variations of the name such as the layout design problem in [28], the spatial configuration problem in [29], cutting stock or trim loss problem, bin or strip packing problem, vehicle, pallet or container loading problem, nesting problem, knapsack problem, etc. The C&P problems are present in various forms and variants depending on the objectives of the problem at hand and the constraints present during approaching the problem. The main objectives of a C&P problem are to reduce the computation time and to maximize the material utilization by reducing the trim loss and increasing the packing efficiency. The latter objective is particularly very important for big industries with mass production because the total trim loss is reduced leading to massive savings [30]. The most spotted nesting problem in literature was the layout problem. Several techniques have been developed over the years to tackle the layout problem, which can be categorized into: exact methods [6], [7], [31], heuristics [10]-[12], [32], and meta-heuristics [15]-[18]. More recent approaches [25], [26], [33] utilize Deep Reinforcement Learning (DRL).

Contour Similarity and GCI. In order to increase the compactness and reduce the scrap while solving the layout problem, the “contour similarity” concept was introduced in the literature of the 2D-bin packing [34], [35]. The contour similarity aims to match the new parts with the sheet's unoccupied closed polygons having similar contour. A time exhaustive approach to find contour similarity was first studied by searching for the new part's optimal angle with a fixed angle step size [36]-[38]. More recently, the contour similarity was researched in the field of additive manufacturing through the Freeman chain code in [34] and using the longest similarity subsequence (LCSS) approach in [35]. In this work, we introduce the concept of geometrical compatibility, which differs from the contour similarity concept in different aspects. (1) Contour similarity is a specific case from the geometrical compatibility; if two parts are geometrically compatible, they will be nested together on the same sheet, but they will not necessarily be adjacent on the sheet, as it would be the case for contour similarity. (2) Contour similarity is computed pair-wise and would be time exhausting if computed for all possible pairs inside a group of parts. On the other hand, GCI is computed graph-wise and considers relationships between all parts at once in the GRG. For instance, in [35], contour similarity was calculated using an iteration-based algorithm, LCSS, which at its best has a time complexity of O(n·m) where n and m are the lengths of the two input sequences. GCI is estimated using a learning-based algorithm with a O(1) time complexity at inference time. (3) Lastly, contour similarity targets the layout problem, unlike GCI, which focuses on the grouping problem.

### B. Graph Neural Networks

GNNs are widely used for classification. There exist three typical classification tasks in a graph: node classification, edge classification, and node and edge classification. The classification task is either based on node features only (e.g., GraphSAGE [39] and DeepWalk [40]) or on both node and edge features (e.g., EGNN [41]). Graph Convolutional

$${X}^{′} {D}^{- 1 / 2} \text{?} A \text{?} {\hat{D}}^{1 / 2} X Θ \qquad ( 7 )$$

$$\text{?} \text{indicates text missing or illegible when filed}$$

is a convolutional operator first introduced in [42]. GCNConv is one of the most widely used architectures for classification in graphs. The majority of graph neural network models share a largely universal architecture which is based on using a message passing function to aggregate information from neighbor nodes into the current node. The main message passing function used in the forward path of the GCNConv is given by
where

$$\hat{A} = A + I \qquad ( 8 )$$

In Equation (7), A is the adjacency matrix of the input graph representing which nodes are connected together. The adjacency matrix would be a matrix of ones if the input graph is a fully connected graph, which applies to the GRG. Â represents the adjacency matrix with self-loops inserted, i.e., each node is connected to itself which is depicted by the identity matrix I. The adjacency matrix is also known as the “edge weights matrix” when it contains values that indicate how closely connected the nodes are to one another rather than only values that indicate the nodes' connectivity (zeros and ones). \hat{D} is the diagonal node degree matrix, where the diagonal element corresponds to the number of edges connected to the node, namely, \hat{D}ᵢᵢ=Σⱼ₌₁^{N}Âᵢⱼ. Furthermore, X denotes a matrix of node feature vectors, Θ is the trainable weight matrix for the GCNConv layer, and X′ is the weighted aggregation of the features of the neighbor nodes.

In this work, the values of the adjacency matrix are determined by means of the GCI. The GCI, however, is not known a priori and thus, has to be learned. Learning the GCI corresponds to an edge labeling problem. Current approaches, such as EGNN [41], cannot be used, though, as they assume the existence of some node labels that do not exist in our case. For this, we propose a hybrid approach using DRL that combines previous techniques to overcome the problem of missing labeled data.

### C. CVRP

The Vehicle Routing Problem (VRP) is an NP-hard optimization problem and is substantially a generalization of the well-known traveling salesman problem (TSP). It is used in supply chain management to design an optimal route for a fleet of vehicles to serve customers under a set of constraints. The common constraints between all the VRP types are minimizing the global distance between customers and the number of vehicles needed to serve all customers. The VRP has been extensively studied in literature through many heuristics and meta-heuristic algorithms surveyed in [43], [44]. There are two main variants of the VRP, the VRP with Time Windows (VRPTW) and the capacitated VRP (CVRP). The third constraint for the VRPTW is to serve all the customers within a predefined time window. CVRP assumes that all the vehicles in the fleet have a uniform capacity and the customers have known demand for a single commodity. To solve CVRP, a third extra constraint must be fulfilled: each vehicle must not exceed its capacity. This work makes an analogy between GRG and CVRP to group the parts based on their GCIs.

### D. Actor-Critic Reinforcement Learning

Reinforcement learning is a decision-making framework where an agent represents the solver of the problem, and an environment represents the problem to be solved. At each state of solving the problem, the agent interacts with the environment by selecting an action to be applied. By applying the action, the environment updates its state and returns the new state and a scalar reward evaluating the quality of the action taken to the agent. In any state, the agent selects the action by following a policy. The agent's goal is to optimize its policy by maximizing the total accumulated reward, also called the return. To decide on actions to be taken in future states, the agent indirectly uses past experiences by building an estimation function of the return called the value function. One widely used agent's paradigm is the actor-critic paradigm, where the actor tries to optimize the policy, and the critic tries to optimize the value function. The actor-critic algorithms can be categorized based on two criteria [45]: whether a discounted [46]-[48] or an average reward [49]-[51] setting is used, and whether the policy's parameters are updated using the standard (also known as vanilla) gradient [52]-[54] or the natural gradient [55], [56]. The central concept behind all the actor-critic algorithms is that the value function estimated and optimized by the critic is used to guide the actor's policy to the improvement direction of performance.

### VI. METHODOLOGY

In this section, we present the proposed approach to solving the grouping problem. First, we present an overview of the different components of our approach, then we present the parts encoding, the architectures of actor and critic modules and the learning routine.

### A. Overview of the Proposed Approach

Our approach consists of finding the mappings π₁ and π₂. The proposed framework consists of four components:
1) Input Encoder: It takes as input a part n and generates as output the part's geometrical information vector gₙ.
2) Actor-Critic-Like Agent: It represents the first policy π₁ mapping from parts to GCIs. It consists of two modules, namely, the Actor-Like module and the Critic-Like module. The input of this component is the set {g₁, . . . , g_{N}} and its output is the GRG where the parts are the nodes and the weights of the edges are the GCIs. During the training phase, it learns the values of the GCIs, that improve the quality of the nesting, with the help of the reward signal provided by the nesting environment in an RL framework. During the inference phase, it predicts the values of the GCIs to build the GRG.
3) CVRP Solver: It represents the second policy π₂ mapping from GCIs to groups. This component considers the GRG, built by the previous component, as a CVRP problem and solves it using meta-heuristics. Its input is the GRG and it outputs sub-graphs of the GRG as routes. Each resulting GRG sub-graph represents a group of parts to be nested together on the same sheet.
4) Nesting Environment: It solves the layout problem for the parts of each GRG sub-graph, and returns the reward of Equation (6) to the Actor-Critic-Like agent during the training phase. During inference, it only solves the layout problem for each group of parts without returning any reward.

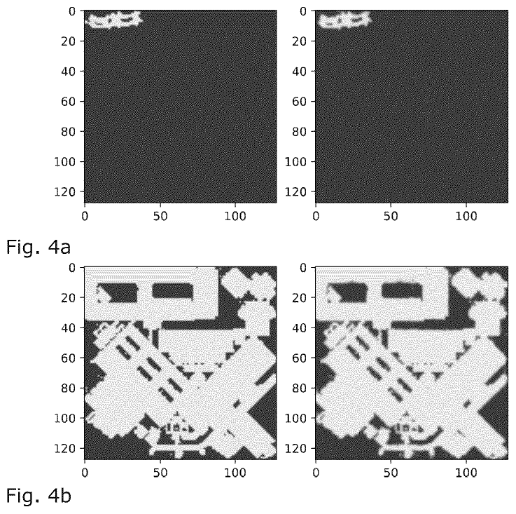

FIG. 4 exhibits a block-diagram of the four components. In the second and third subsections, the first and second components, will be respectively explained in details. The third and fourth components will be explained in the learning routine of the last subsection as they cannot be explained alone.

### B. Input Encoding

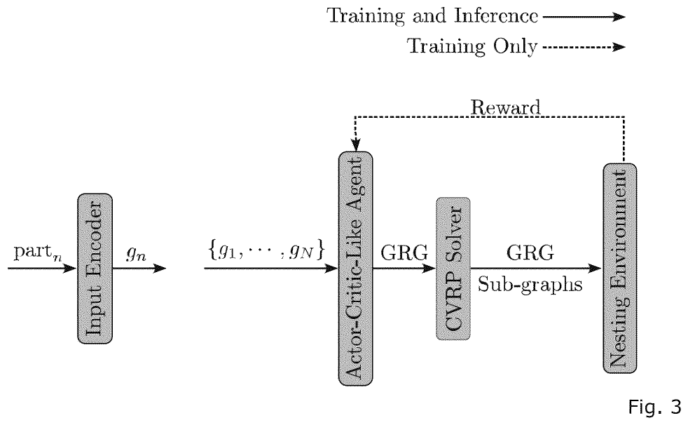

The input to our algorithm is the set of parts to be nested, where each part is described by its area and its geometrical shape. To alleviate the task of the first policy, π₁, we encode the geometrical shape of each part, described as a rasterized image, into a geometrical information vector. Inspired by representation learning, the rasterized image of each part is encoded using an autoencoder into a vector gₙ in R^{d}, where d=256, as a preprocessing step. An encoding of the parts would facilitate the GCI learning task and optimize needed computation resources by reducing dimensionality. The encoded geometrical information vector gₙ of a part n will be further used as its GRG node's features in Subsection VI-C. A customized autoencoder based on the inception network [57] was trained on a different datasets of more than 10, 000 rasterized parts including some layouts images. To evaluate the encoding generalization on new images, the autoencoder has been tested on unseen new images of single parts (FIG. 3(a)) and layouts (FIG. 3(b)).

### C. Actor-Critic-Like Architecture

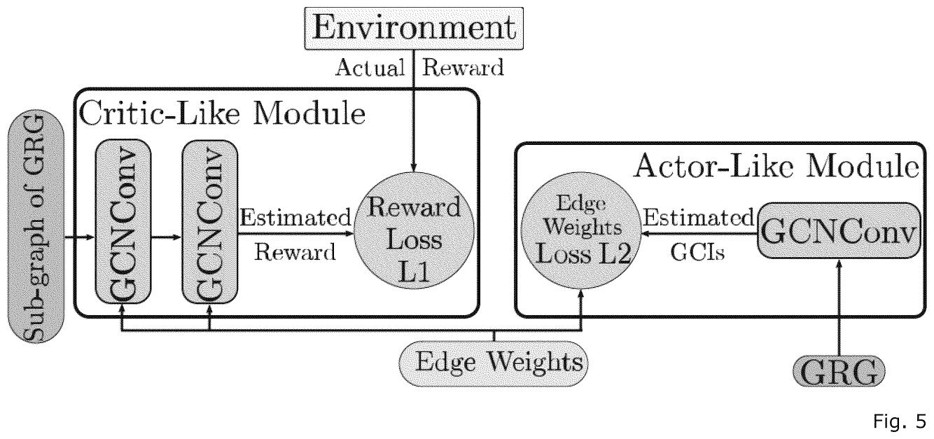

Motivated by the “learning with a critic” concept [58], which incited Sutton, Barto, and Anderson [59] to outline the fundamental concepts of all the modern Actor-Critic algorithms in the RL field, our model consists of two modules: actor-like and critc-like modules (FIG. 5).

a) Critic-Like Module: In the critic-like module, the nodes of a sub-graph of the GRG are passed through two consecutive GCNConv layers to perform message passing between the nodes. The rationale for using a sub-graph rather than the entire GRG will become clear in the “Data Collection” step of Subsection VI-D. Both GCNConv layers take initially a random edge weights matrix representing the GCIs. The output, of the first GCNConv layer is then provided as input to the second GCNConv layer. Theoretically speaking, in Equation (8), the matrix of node geometrical information vectors [g₁, . . . , g_{N}] of the input graph represents the X, while the edge weights represent the Â matrix and are learnable parameters.

To guide the improvement of the actor-like module, the final GCNConv layer's outputs are averaged to a single value estimating the environment's reward. This value is compared to the ground-truth reward signal coming from the environment using a L₁ loss function. The L₁ loss is further used in backpropagation with Stochastic Gradient Descent (SGD) to update the parameters of the 2 GCNConv layers and the edge weights matrix. Each parameter of this edge weights matrix stands for a GCI between its connecting nodes (i.e. parts).

Actor-Like Module: The actor-like module consists of one GCNConv layer, which takes the nodes of the GRG as input and an adjacency matrix of ones (as it is assumed that all nodes are connected). The goal of the actor-like module is to learn a forward mapping between the input graph nodes and the edge weights Âₑₛₜᵢₘₐₜₑ, which is a matrix of dimensions N×N, where N is the number of the nodes in the graph. After updating the edge weights of the critic-like module, the L₂ loss function is computed between the output of the actor-like module Abestimate and the edge weights A ^{b}learned by the critic-like module. The parameters of the actor-like module's GCNConv layer are then updated by SGD in backpropagation.

The actor-like module learns an edge-labeling task.

It might be mistakenly thought that the critic-like module has achieved the whole task by learning the edge weights, and the actor-like module is redundant. Practically speaking, this is partially true. The critic-like module learns the GCIs by backpropagating on the learnable parameters of the edge weights matrix. However, the critic-like module maps the input nodes and the GCIs to a reward function and only learns the GCIs by backpropagation, which is impossible at test time.

In simple words, we can say that the critic-like module has no memory for learned knowledge. The role of the actor-like module is to generalize the knowledge learned by the critic-like module.

a) Actor-Critic-Like vs. Actor-Critic: The actor-critic and actor-critic-like paradigms agree on the concept but differ on its implementation. The critic in the actor-critic paradigm implicitly improves the actor, by insinuating the direction of actions update from an evaluation signal (e.g. v-value, q-value, a-value or return). On the other hand, the critic-like in the actor-critic-like paradigm explicitly learns the good actions by directly estimating the reward signal and teach the actor those actions. The actor and critic have “act then get criticized” dynamics: the actor takes action first and then the critic evaluates its performance. The dynamics between the actor-like and critic-like are rather “get criticized and then learn”: the critic-like learns explicit action by evaluating it, and then the actor-like learn this action.

### D. Learning Routine

The GCIs of the GRG could only be learned by nesting the parts of the GRG on sheets and evaluating the layouts quality in a RL framework. In this section, the GCI's, and accordingly the GRG's, learning procedure (Algorithm 1) is explained in details.

a) Initialization of the environment: The first step is to initialize a nesting environment. In the RL context, the action-space consists of all the sets of parts that could be nested together on the same sheet, i.e. each action is a sub-graph of the GRG. The state-space includes only the initial state which is the set of all parts in the GRG. In other words, there exists only one state which is the whole GRG graph, and each action is a sub-graph of the GRG that the agent believes that its parts will be geometrically fitting together on the same sheet. The environment takes a sub-graph, nests its parts on the same sheet, and returns the quality of the resulting layout (Equation (6)) as a “reward” to the agent.

b) Initialize a replay Buffer: To store the experiences collected from the agent and environment interactions, a replay buffer is initialized for the GRG. Each entry of the reply buffer is a pair of binary mask and reward. The mask filters out all the GRG's parts that are not included in the sub-graph. The replay buffer has a limited capacity and once it is full the newest experience replaces the oldest one. This allows an off-policy training, since experiences collected from old policies are used to learn a new one.

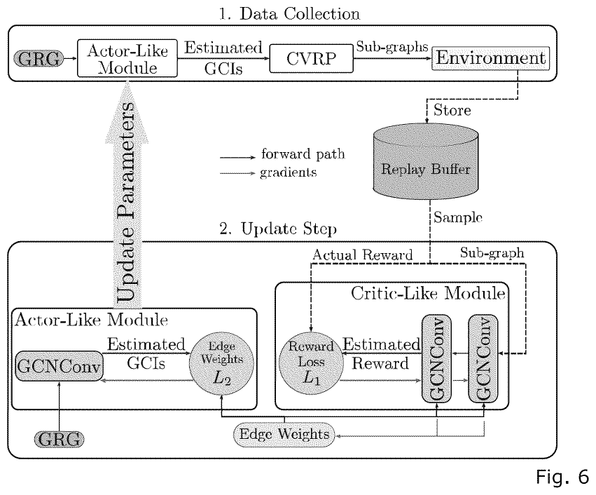

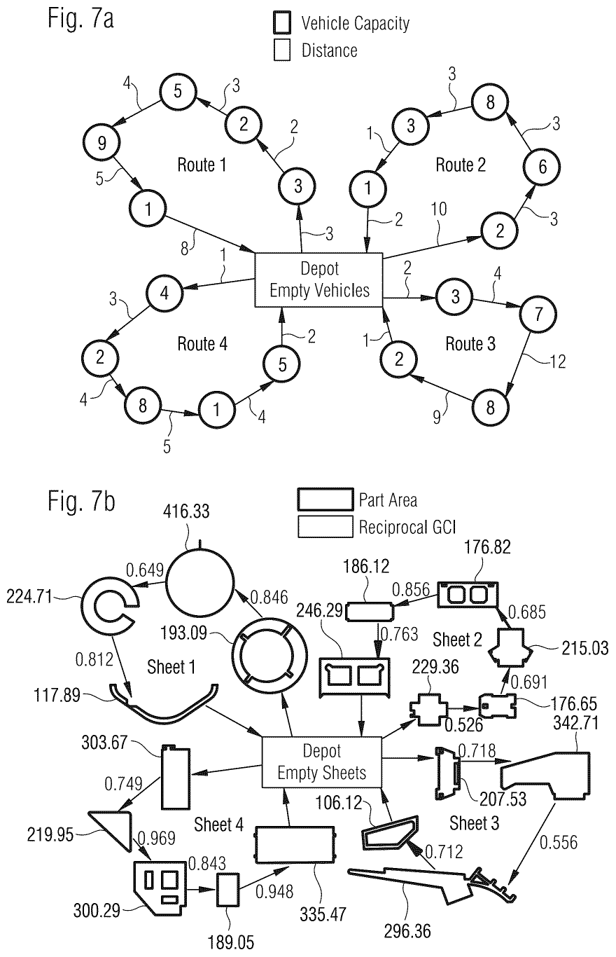

c) Data Collection: In the data collection step (FIG. 6), the GCIs between all parts of the GRG are inferred from the actor-like module. The GRG is then regarded and solved as a CVRP. We draw an analogy between CVRP and GRG in FIG. 7: the black numbers in FIG. 7(b) are the reciprocal of the GCI values, i.e., 1−GCI, and are analogous to the distances between the points in FIG. 7(a). Both need to be minimized. On the other hand, the red numbers in FIG. 7(b) are the areas of the parts, which are similar to the capacities of the points in FIG. 7 (a). Both need to meet the capacity constraints. Finally, the available empty sheets to nest the sub-graphs of the GRG correspond to the available vehicles in its CVRP counterpart. Out of the several meta-heuristic algorithms that handle the CVRP, we used Google OR Tools to solve the GRG into sub-graphs. Each sub-graph is then passed to

Algorithm 1 GCI Learning Routine
1: Initialize a nesting environment
2: Divide the large GRG into η GRGs of N parts each

the environment to be nested on the same sheet and a reward is returned. The mask of the sub-graph and the reward are then stored in the replay buffer.

d) Update Step: To update the actor-like and critic-like

d) Update Step: To update the actor-like and critic-like modules, we sample a random batch of experiences from the replay buffer. The mask of each element in this batch is used to recover the sub-graph and the reward is used to compute the L1 loss and update the critic-like module. After the update of the critic-like module, the whole GRG is used by the actor-like module to estimate the GCIs. Those GCIs are again compared to the edge weights matrix learned by the critic-like module, in a L2 loss function, to update the actor-like module (FIG. 6). Note that the critic-like module has learned the GCIs of the whole GRG by only using sub-graphs from the GRG. This design choice is motivated by the fact that the geometrical compatibility should only be evaluated for clusters of parts to be nested through the reward signal. Hence, by evaluating the quality of many sub-graphs, the critic-like can infer the geometrical compatibility between all the parts of the GRG. Nevertheless, the critic-like module is a transductive model that cannot generalize its learned knowledge of edge weights to unseen GRGs. On the other hand, the actor-like module is an inductive model that can easily predict the GCIs of newly encountered GRGs.

e) Extension to large GRGs: In order to limit the computation resources, the GRG is restricted to comprise at most only N parts. To extend the model on larger datasets which contain N parts with N>N, we divide the big GRG into

$$η = \frac{N}{N}$$

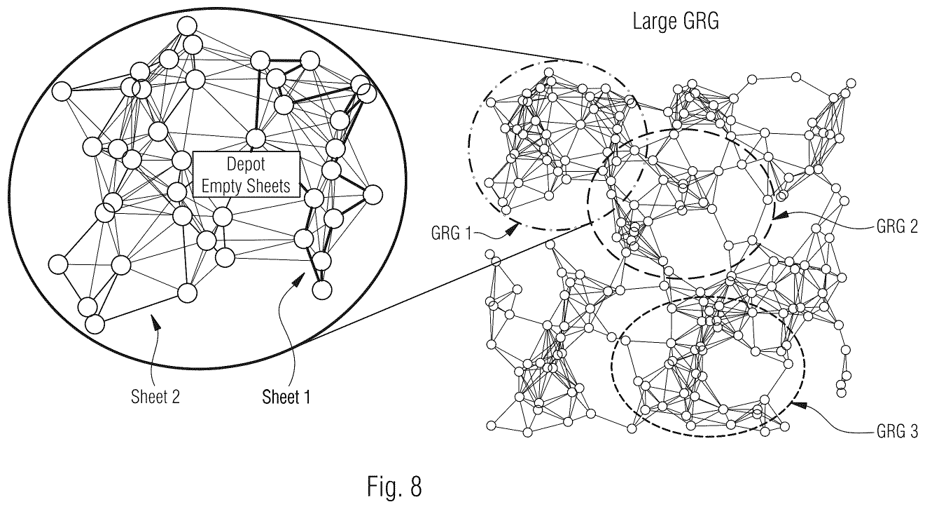

smaller GRGs of N parts each (FIG. 8) in the training phase. The above described learning process will then be applied to each GRG. At the start of training for each GRG, a new replay buffer and an edge weights matrix for the critic-like module are initialized. The edge weights matrix of the critic-like module is randomly initialized only for the first GRG. However, for all the following ones, it is initialized with the previously learned edge weights matrix. This could be thought of as a simple form of transfer learning. In the inference phase, only the actor-like model is used to estimate the GCIs in the test splits.

### VII. EXPERIMENTS AND RESULTS

We perform multiple experiments to showcase the effectiveness of our model. In Section VII-A, we study the effect of different choices for the reward functions for a single GRG with N=500. Next, in Section VII-B, we compare the performance of the proposed model to an open-source nesting software.

Nesting environment. For our experiments, we developed a dummy environment that does not solve the layout problem but rather considers only the parts' areas to calculate the reward of the current nested parts. There are several reasons behind the choice of a dummy environment. First, real nesting environment are very slow, in solving the layout problem, compared to the GNNs and will increase their training time drastically by increasing the data collection time. Second, a dummy environment can be considered as a more general and abstract case of a real nesting environment as the proposed algorithm is not limited to a specific layout-solver algorithm. This design choice constitutes a proof of concept of the GCI and GRG ideas. Realizing the reward function (Equation (6)) in the dummy environment is impossible since this reward is a function of Area(BB_{K}) which is a non-linear function of the geometries and the areas of the nested parts (Equation (2)) that can only be calculated after solving the layout problem. However, in the dummy environment the layout problem is not solved and the bounding box area cannot be computed. To approximately simulate the non-linearity of the reward in (6), we designed the reward function of the dummy environment to be a non-linear function F of the utilization ratio U. For each subgraph (group of parts), formed by the CVRP to be nested on sheet k with area sₖ, the utilization ratio Uₖ and the reward Rₖ are calculated as follows:

$${U}_{k} = \frac{{\sum }_{n = 1}^{N} {x}^{} \text{?} {a}_{n}}{( {s}_{k} )}$$

$${ℛ}_{k} = ℱ ( {U}_{k} )$$

$$\text{?} \text{indicates text missing or illegible when filed}$$

For the selection of F, the effects of two different non-linear functions have been examined in Subsection VII-A.

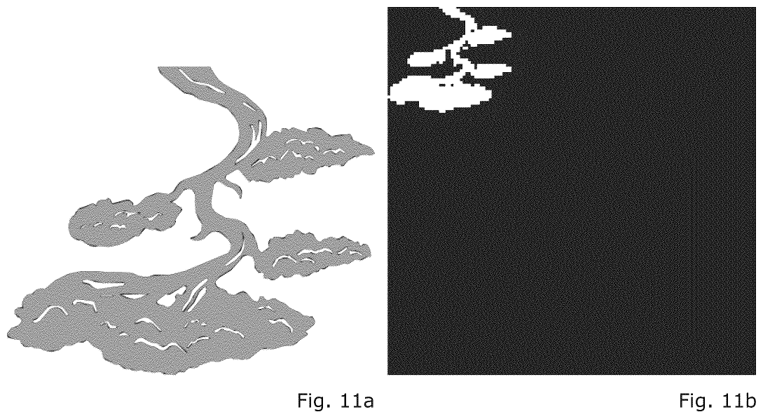

Dataset. Our dataset consists of 2, 500 CAD files representing different irregular complex geometrical parts from sheet metal production. The parts used are to be nested on sheets of size 3000 mm×3000 mm. The CAD files of the parts are translated into Scalable Vector Graphics (SVG) format. To capture the difference of dimensions between parts, the canvas is set as a constant frame of reference. Each part is placed at the top left corner of the canvas and is rasterized into a 128×128 pixels binary image as shown in FIG. 11(b). We divide our dataset into a training set (2, 000 parts) and a test set of 500 parts. Two tests splits are further selected from the test set and used to evaluate the models. Test Split 1 contains 113 parts with regular shapes, while Test Split 2 contains 124 parts with irregular shapes. Regular shapes contain mostly straight lines, smooth curves. On the other hand, irregular shapes have more complex concave and convex curves. The test splits were selected on the base of manual inspection. All the parts in the test splits are different from each other and from the training split.

### A. Effect of Different Reward Functions on the Model Generalization

In this set of experiments, we select only 500 parts from the training set to train the models, which can be grouped into one GRG. We experiment with two different non-linear functions F for the reward calculation to test the generalization ability of the proposed model. We train the first model using a sinusoidal function of the utilization ratio as follows: Rₖ=sin ((Uₖ−0.5)·π). The range of the utilization is set to [−0.5, 0.5] to make the reward range between [−1, 1]. The second model uses a sigmoid function for the reward. This reward is also non-linear and represents a different challenge to the agent. The reward function is expressed as follows:

$${R}_{k} = \frac{1}{1 + {e}^{- {U}_{k}}} .$$

In this case, the range of the reward is [0, 1].

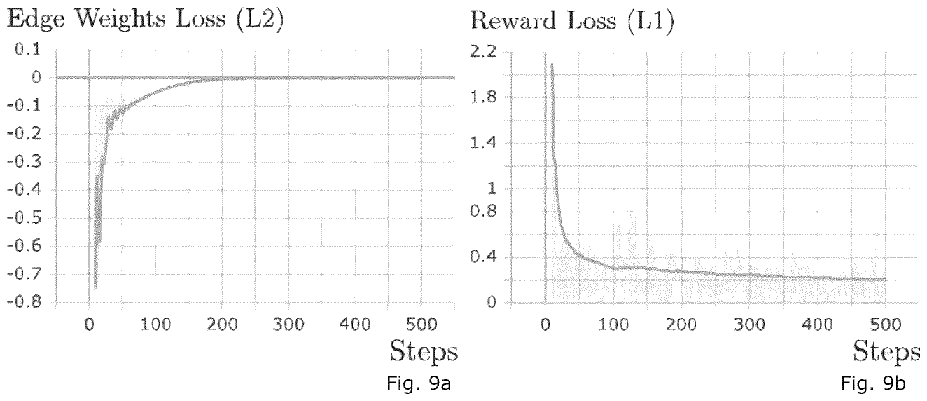

Model a. In this model, the reward function is a non-linear sinusoidal function. FIG. 9(a) shows the edge weights error L₂ during the 500 training steps under the Sinusoidal reward function. It can be noted that L₂ loss converges quickly to a relatively small value. FIG. 9(b) shows the reward loss L1 which exhibits the same convergence behaviour.

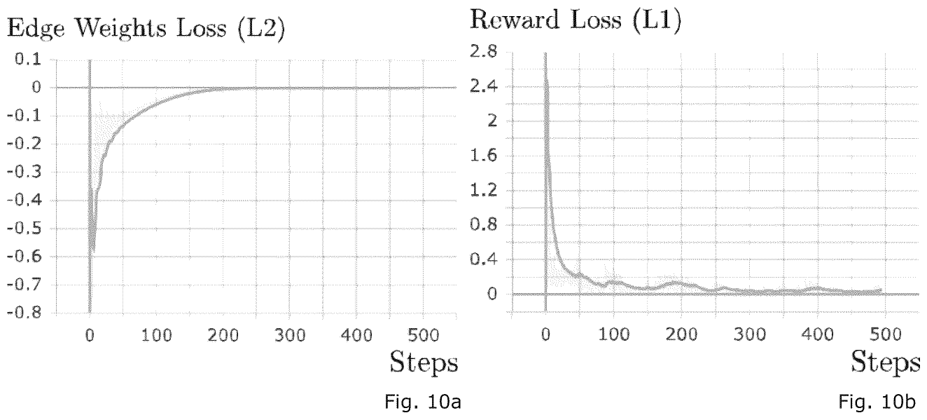

Model b. In this model, we use a Sigmoid reward function. FIG. 10(a) shows the edge weights error L₂ during the 500 training steps. Similar to model a, the L₂ loss and L₁ loss converge quickly (see FIG. 10(b)).

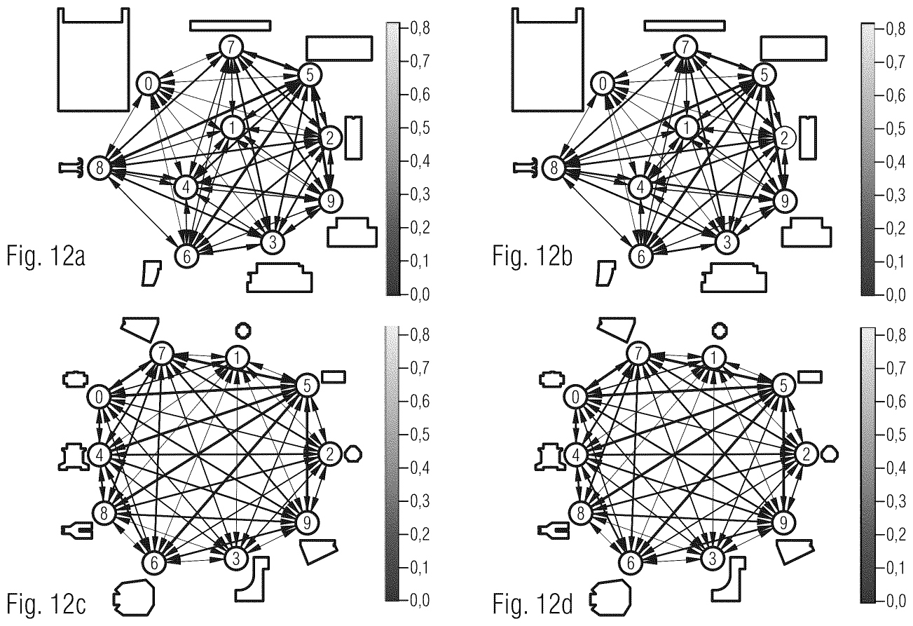

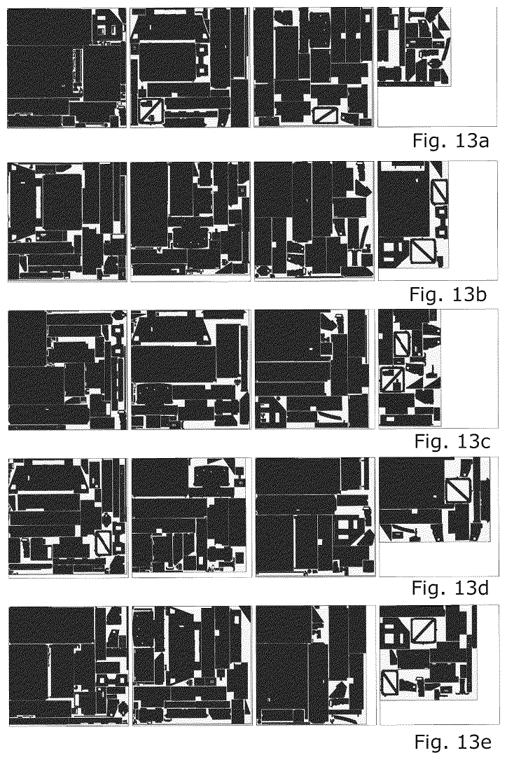

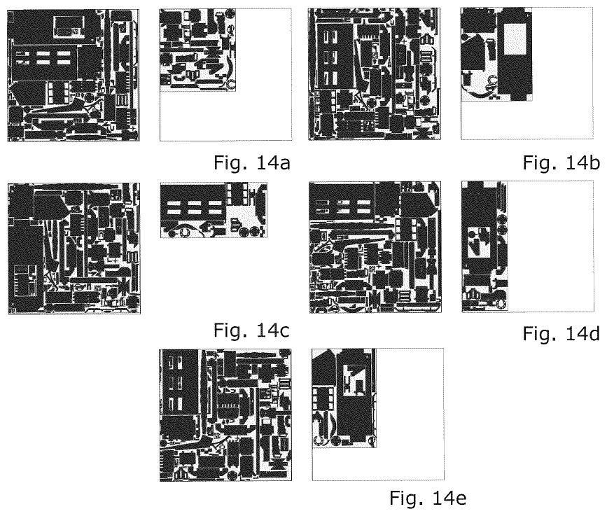

We show the estimated GCI for models a and b on test split 1 in FIG. 12(a), and FIG. 12(b). Qualitatively, we can see that the graphs are similar with few exceptions.

### A. GRG vs Existing Nesting Software

To the best of our knowledge, the nesting sub-problem of grouping the parts to be nested into clusters before doing the nesting itself has never been handled before by any nesting software. Almost all of the current nesting software are trying to solve two other nesting sub-problems, namely finding the best order of the parts to nest, and selecting the angle and xy-position of each part on the sheet, i.e., the nesting/packing itself. After selecting the nesting order of the parts, usually through meta-heuristics, and during packing the parts on the sheet, the parts that do not fit on the current sheet are placed on a new one. That's how the clustering sub-problem is solved in the nesting software without taking into consideration the suitability of the parts to be nested together.

To get a sense of how our approach compares to other existing frameworks, we conducted an experiment to compare the performance of our framework to the performance of an open-source nesting software called DeepNestPort. DeepNest-Port is substantially a port for a browser-based vector nesting tool called SVGNest to handle different input/output image formats. We choose DeepNestPort as a baseline to compare with for three reasons: (1) it's an open-source software which makes it easily accessible for research purposes, (2) SVGNest claims to have a similar performance to commercial software and (3) other learning frameworks which solve the layout problem operate only on a smaller number of regular parts, and are not suitable to operate on a large number of regular and irregular parts. It should be noted that we used only a simple dummy environment throughout the training of our model which we expect to affect the results negatively. Training with one of the existing nesting software as environment would be impossible, as they are very slow and therefore not suitable for an RL training which needs huge amounts of samples to learn from.

Baseline and models. In this experiment, we first give all parts in each test split to the DeepNestPort framework to nest. The performance of this experiment is considered the baseline. Then, we report the performance of four models: models a and b trained twice, on 500 parts and 2, 000 parts. For each model, we estimate the GCI values of the parts and split them with CVRP. Then, we nest each group of parts, corresponding to a specific route from the CVRP problem, on a sheet using DeepNestPort. The main difference is that DeepNestPort assigns the parts to each sheet on its own, while in our case, the parts are assigned according to their GCIs.

Metrics. We evaluate the performance of our model using two metrics: time (T) and wasted material (WM). Time (in seconds) is calculated by measuring the nesting time of all used sheets after the proposed grouping operation. Wasted material (expressed as a percentage) is the ratio of the sum of wasted areas in all used sheets over the total area of the sheets. The wasted area of a sheet is considered as only the unused area inside the rectangular bounding box enclosing all the parts nested on a sheet. The unenclosed area could be reused to nest new parts. Therefore it is not considered scrap.

Results and Discussion The results are reported in Table I. In case of using DeepNestPort, a total number of four and two sheets each of the dimension 3000 mm×3000 mm were needed to nest the required 113 and 124 parts of test split 1 and 2, respectively (refer to Appendix VIII for layouts visualization). Test splits 1 and 2 were nested in an average time of 600 sec and 761 sec and the material wasted percentage in this case was 13% and 20% of the total area of the used sheets respectively. In the case of using GCIs, a total number of 4 sheets was suggested for test split 1 and 2 sheets for test split 2.

From the table, we first notice that Model a generalizes better than Model b in all combinations. This shows empirically that the sinusoidal reward is better suited than the sigmoid reward. Second, both models achieve better than the baseline on test split 2, with Model b resulting in only 7% material waste, almost 3 times less than DeepNestPort, when trained on 2000 parts. Model b still achieves a considerable reduction when trained only on 500 parts. The difference in the two results can be explained away by the number of parts during training. Both models a and b however experience a slight degradation in performance on test split 1. We hypothesize that this effect could be mitigated by designing a more realistic nesting environment or tuning the choice of the reward function.

Overall, the framework consistently achieves a lower operating time than the classical nesting approach in all combinations. The operating time is reduced on average by 48% on test split 1 and by 30% on test split 2. The longer time in test split 2 is attributed to the irregular shapes of the parts. This stems from the fact that solving the grouping problem implicitly during the layout problem results in a large number of combinations which the nesting environment should consider. In contrast, the proposed pipeline divides the parts to be nested into small groups with more compatible parts, which in turn can be nested directly on the sheets in fewer combinations.

Limitations. One limitation of this work is that no nesting environment was used during the training. However, this is a promising result, because the model can achieve a considerable reduction in time and waste material on irregular parts. We believe that the use of a realistic nesting environment during the training will further reduce the material waste. However, the design of such an environment is out-of-the-scope of this work and is considered in future works.

Another limitation of the proposed framework is that the use of meta-heuristics to solve the CVRP problem might lead to sub-optimal results or even no results at all in an acceptable time frame. We plan to address this issue in future works by replacing meta-heuristics with a plug-and-play learning-based approach, e.g. [60]. Overall, these results validate our hypothesis, that a different pipeline design (where the grouping problem is solved before the layout problem) can significantly speed up the nesting process and reduce the scrap produced.

| | | Test Split 1 | | Test Split 2 | |
|---|---|---|---|---|---|
| Experiments | Training | T (sec) | WM (%) | T/sec | WM/% |
| Deep Nest Port | NA | 600 | 13 | 761 | 20 |
| Model a | 500 parts | 300 | 15 | 610 | 12 |
| Model b | | 285 | 18 | 521 | 19 |
| Model a | 2000 parts | 317 | 17 | 498 | 7 |
| Model b | | 353 | 18 | 498 | 20 |
| Average | | 313.7 | 17 | 531.7 | 14.5 |

The above tabel (TABLE I) shows a comparison between GRG and DeepNestPort. Test Split 1 contains regular parts, while Test Split 2 contains irregular parts. Best numbers are marked in bold.

In this work, we revisit the conventional nesting pipeline by directly solving the grouping problem of parts before the arrangement problem. To achieve this, we introduced and formally defined two new concepts, namely GRG and GCI. We proposed an RL-based framework to estimate the GCIs of parts in an unsupervised way. The framework consists of two GNNs trained in an actor-critic-like fashion, where the actor estimates the GCIs and the critic judges their quality by fitting the reward function of a nesting environment. The proposed framework was tested on two dummy environments with different non-linear reward functions. Comparison with an open-source nesting software was conducted to showcase the performance of the proposed grouping and nesting pipeline. We demonstrate the effectiveness of the framework by achieving a three-fold improvement in the waste material on a test split with irregular shapes and a 34% improvement in operating time. Similarly, the model achieves a 50% reduction in time with a minimal sacrifice in waste material on another test split with regular parts. In future works, we plan on completing the pipeline by developing a smart nesting algorithm for the layout problem.

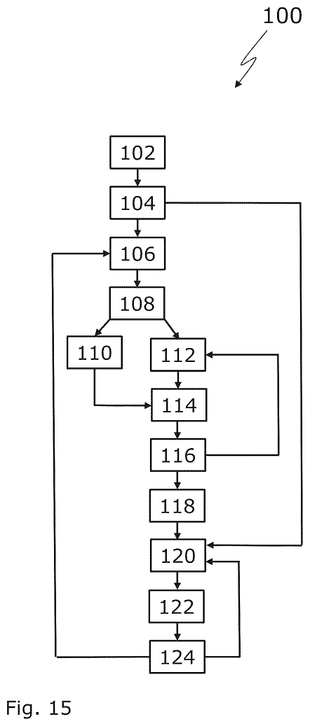

FIG. 15 schematically shows the process of determining parameters GCI (Geometrical compatibility index) for all pairs of parts in a training phase 100 of the method according to embodiments of the invention for selecting the parts to be placed on sheets. In a first step 102, the geometric features of each part is encoded in a respective geometric information vector, where for each part one of the geometric features is the projected area of the part in plan view (wherein the first step 102 can also be carried out independently of the training phase). In a second step 104, a graph is generated, wherein the geometric features of each part are assigned to one node of the graph at a time. All nodes of the graph are connected in pairs by one edge at a time (wherein the second step 104 can also be carried out independently of the training phase). In a third step 106, estimated values of the GCI are set, where each estimated value of the GCI is assigned to a pair of the parts respectively. Furthermore, first edge weights are assigned to the edges of the graph, where each first edge weight depends on the respective GCI assigned to the edge (i.e. the corresponding pair of parts). In a fourth step 108, the parts are assigned to the sheets. The assignment is carried out by determining subgraphs through the nodes of the graph by an optimization method. The nodes through which a respective subgraph passes represent the parts to be placed on a sheet, wherein the sum of the projected areas of the parts on each subgraph is at most equal to the respective sheet size. The optimization method is in particular a method used to solve the capacitated vehicle routing problem (CVRP).

In a fifth step 110, a reward function value for each subgraph is determined as a measure of how much of the surface area of the respective sheet is covered by the parts on cach subgraph after the parts are nested on the respective sheet. In a sixth step 112, a suitability value for each subgraph is determined in the form of an (in particular) arithmetic average of output values for the respective subgraph, where the output values take into account the estimated values of the GCI. The output values are in particular calculated by a critic-like module using Graph Convolutional Neural Networks. In a seventh step 114, a reward loss is determined on each subgraph, where the reward loss depends on the reward function value and the suitability value. In an eighth step 116, the GCI on cach subgraph are redetermined such that the reward loss is reduced on each subgraph. In a ninth step 118, the steps 110 through 116 are repeated until the reward loss mects a first termination criterion. In particular, values of the GCI in the critic-like module are determined in this way. In a tenth step 120, second edge weights of the edges of the graph are estimated. The tenth step 120 is in particular carried out by an actor-like module. Furthermore, edge weight losses at the edges of the graph are determined, wherein the edge weight losses depend on the second edge weights and the GCI determined in the ninth step 118 at the respective edges.

In an eleventh step 122, the step 120 is repeated, wherein estimating the second edge weights is performed such that the edge weight losses are minimized until the edge weight losses meet a second termination criterion. In a twelfth step 124, values of the GCI are obtained from the procedure according to step 122. Steps 106 through 124 are repeated thereafter, wherein the estimated values of the GCI in step 106 are set to be the second edge weights last determined in step 124 until the estimated values of the GCI meet a third termination criterion.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCES

[1] M. Arenales, R. Morabito, and H. Yanasse, “Special issue: Cutting and packing problems,” Pesquisa Operacional, vol. 19, no. 2, pp. 107-299, 1999.
[2] H. Dyckhoff, “A typology of cutting and packing problems,” European Journal of Operational Research, vol. 44, no. 2, pp. 145-159, 1990.
[3] G. Wäscher, H. Haußner, and H. Schumann, “An improved typology of cutting and packing problems,” European journal of operational research, vol. 183, no. 3, pp. 1109-1130, 2007.
[4] L. Faina, “A survey on the cutting and packing problems,” Bollettino dell'Unione Matematica Italiana, vol. 13, no. 4, pp. 567-572, 2020.
[5] C. Chen, S.-M. Lee, and Q. Shen, “An analytical model for the container loading problem,” European Journal of operational research, vol. 80, no. 1, pp. 68-76, 1995.
[6] A. Lodi and M. Monaci, “Integer linear programming models for 2-staged two-dimensional knapsack problems,” Mathematical Programming, vol. 94, no. 2, pp. 257-278, 2003.
[7] A. Lodi, S. Martello, and D. Vigo, “Models and bounds for two-dimensional level packing problems,” Journal of Combinatorial Optimization, vol. 8, no. 3, pp. 363-379, 2004.
[8] J. Puchinger and G. R. Raidl, “Models and algorithms for three-stage two-dimensional bin packing,” European Journal of Operational Research, vol. 183, no. 3, pp. 1304-1327, 2007.
[9] F. Furini and E. Malaguti, “Models for the two-dimensional two-stage cutting stock problem with multiple stock size,” Computers & Operations Research, vol. 40, no. 8, pp. 1953-1962, 2013.
[10] E. K. Burke, G. Kendall, and G. Whitwell, “A new placement heuristic for the orthogonal stock-cutting problem,” Operations Research, vol. 52, no. 4, pp. 655-671, 2004.
[11] S. Imahori and M. Yagiura, “The best-fit heuristic for the rectangular strip packing problem: An efficient implementation and the worst-case approximation ratio,” Computers & Operations Research, vol. 37, no. 2, pp. 325-333, 2010.
[12] J. Verstichel, P. De Causmaecker, and G. V. Berghe, “An improved best-fit heuristic for the orthogonal strip packing problem,” International Transactions in Operational Research, vol. 20, no. 5, pp. 711-730, 2013.
[13] E. “Ozcan, Z. Kai, and J. H. Drake, “Bidirectional best-fit heuristic considering compound placement for two dimensional orthogonal rectangular strip packing,” Expert Systems with Applications, vol. 40, no. 10, pp. 4035-4043, 2013.
[14] E. Hopper and B. C. Turton, “A review of the application of meta-heuristic algorithms to 2d strip packing problems,” Artificial Intelligence Review, vol. 16, no. 4, pp. 257-300, 2001.
[15] “An empirical investigation of meta-heuristic and heuristic algorithms for a 2d packing problem,” European Journal of Operational Research, vol. 128, no. 1, pp. 34-57, 2001.
[16] S. C. Leung, D. Zhang, and K. M. Sim, “A two-stage intelligent search algorithm for the two-dimensional strip packing problem,” European Journal of Operational Research, vol. 215, no. 1, pp. 57-69, 2011.
[17] K. Sörensen and F. Glover, “Metaheuristics,” Encyclopedia of operations research and management science, vol. 62, pp. 960-970, 2013.
[18] E. Hopper and B. Turton, “Application of genetic algorithms to packing problems—a review,” Soft Computing in Engineering Design and Manufacturing, pp. 279-288, 1998.
[19] P. Poshyanonda and C. H. Dagli, “Genetic neuro-nester,” Journal of Intelligent Manufacturing, vol. 15, no. 2, pp. 201-218, 2004.
[20] R. Labib and R. Assadi, “Modified multi-layered perceptron applied to packing and covering problems,” Neural Computing and Applications, vol. 16, no. 2, pp. 173-186, 2007.
[21] H. Hu, X. Zhang, X. Yan, L. Wang, and Y. Xu, “Solving a new 3d bin packing problem with deep reinforcement learning method,” arXiv preprint arXiv:1708.05930, 2017.
[22] A. Laterre, Y. Fu, M. K. Jabri, A.-S. Cohen, D. Kas, K. Hajjar, T. S. Dahl, A. Kerkeni, and K. Beguir, “Ranked reward: Enabling self-play reinforcement learning for combinatorial optimization,” arXiv preprint arXiv:1807.01672, 2018.
[23] O. Kundu, S. Dutta, and S. Kumar, “Deep-pack: A vision-based 2d online bin packing algorithm with deep reinforcement learning,” in 2019 28th IEEE International Conference on Robot and Human Interactive Communication (RO-MAN). IEEE, 2019, pp. 1-7.
[24] H. Zhao, Q. She, C. Zhu, Y. Yang, and K. Xu, “Online 3d bin packing with constrained deep reinforcement learning,” in Proceedings of the AAAI Conference on Artificial Intelligence, vol. 35, no. 1, 2021, pp. 741-749.
[25] R. Hu, J. Xu, B. Chen, M. Gong, H. Zhang, and H. Huang, “Tap-net: transport-and-pack using reinforcement learning,” ACM Transactions on Graphics (TOG), vol. 39, no. 6, pp. 1-15, 2020.
[26] R. Verma, A. Singhal, H. Khadilkar, A. Basumatary, S. Nayak, H. V. Singh, S. Kumar, and R. Sinha, “A generalized reinforcement learning algorithm for online 3d bin-packing,” arXiv preprint arXiv:2007.00463, 2020.
[27] Y. Wu, W. Li, M. Goh, and R. De Souza, “Three-dimensional bin packing problem with variable bin height,” European journal of operational research, vol. 202, no. 2, pp. 347-355, 2010.
[28] J. Cagan, K. Shimada, and S. Yin, “A survey of computational approaches to three-dimensional layout problems,” Computer-Aided Design, vol. 34, no. 8, pp. 597-611, 2002.
[29] J. Michalek, R. Choudhary, and P. Papalambros, “Architectural layout design optimization,” Engineering optimization, vol. 34, no. 5, pp. 461-484, 2002.
[30] J. F. Oliveira, A. Neuenfeldt Junior, E. Silva, and M. A. Carravilla, “A survey on heuristics for the two-dimensional rectangular strip packing problem,” Pesquisa Operacional, vol. 36, pp. 197-226, 2016.
[31] B. S. Baker, E. G. Coffman, Jr, and R. L. Rivest, “Orthogonal packings in two dimensions,” SIAM Journal on computing, vol. 9, no. 4, pp. 846-855, 1980.
[32] D. Zhang, L. Shi, S. C. Leung, and T. Wu, “A priority heuristic for the guillotine rectangular packing problem,” Information Processing Letters, vol. 116, no. 1, pp. 15-21, 2016.
[33] H. Zhao, Q. She, C. Zhu, Y. Yang, and K. Xu, “Online 3d bin packing with constrained deep reinforcement learning,” ar Xiv preprint arXiv:2006.14978, 2020.
[34] B. Guo, J. Hu, F. Wu, and Q. Peng, “Automatic layout of 2d free-form shapes based on geometric similarity feature searching and fuzzy matching,” Journal of Manufacturing Systems, vol. 56, pp. 37-49, 2020.
[35] Y. Yang, B. Liu, H. Li, X. Li, G. Wang, and S. Li, “A nesting optimization method based on digital contour similarity matching for additive manufacturing,” Journal of Intelligent Manufacturing, pp. 1-23, 2022.
[36] J. Bła'zewicz, P. Hawryluk, and R. Walkowiak, “Using a tabu search approach for solving the two-dimensional irregular cutting problem,” Annals of Operations Research, vol. 41, no. 4, pp. 313-325, 1993.
[37] J. F. Oliveira, A. M. Gomes, and J. S. Ferreira, “Topos-a new constructive algorithm for nesting problems,” OR-Spektrum, vol. 22, no. 2, pp. 263-284, 2000.
[38] A. K. Sato, T. d. C. Martins, and M. d. S. G. Tsuzuki, “A pairwise exact placement algorithm for the irregular nesting problem,” International Journal of Computer Integrated Manufacturing, vol. 29, no. 11, pp. 1177-1189, 2016.
[39] J. Liu, G. P. Ong, and X. Chen, “Graphsage-based traffic speed fore-casting for segment network with sparse data,” IEEE Transactions on Intelligent Transportation Systems, 2020.
[40] B. Perozzi, R. Al-Rfou, and S. Skiena, “Deepwalk: Online learning of social representations,” in Proceedings of the 20th ACM SIGKDD international conference on Knowledge discovery and data mining, 2014, pp. 701-710.
[41] J. Kim, T. Kim, S. Kim, and C. D. Yoo, “Edge-labeling graph neural network for few-shot learning,” in Proceedings of the IEEE/CVF con-ference on computer vision and pattern recognition, 2019, pp. 11-20.
[42] T. N. Kipf and M. Welling, “Semi-supervised classification with graph convolutional networks,” arXiv preprint arXiv:1609.02907, 2016.
[43] G. Laporte, “The vehicle routing problem: An overview of exact and approximate algorithms,” European journal of operational research, vol. 59, no. 3, pp. 345-358, 1992.
[44] J.-F. Cordeau, M. Gendreau, A. Hertz, G. Laporte, and J.-S. Sormany, “New heuristics for the vehicle routing problem,” Logistics systems: design and optimization, pp. 279-297, 2005.
[45] I. Grondman, L. Busoniu, G. A. Lopes, and R. Babuska, “A survey of actor-critic reinforcement learning: Standard and natural policy gradients,” IEEE Transactions on Systems, Man, and Cybernetics, Part C (Applications and Reviews), vol. 42, no. 6, pp. 1291-1307, 2012.
[46] C. Niedzwiedz, I. Elhanany, Z. Liu, and S. Livingston, “A consolidated actor-critic model with function approximation for high-dimensional pomdps,” in AAAI 2008 workshop for advancement in POMDP solvers, 2008, pp. 37-42.
[47] X.-S. Wang, Y.-H. Cheng, and J.-Q. Yi, “A fuzzy actor-critic reinforcement learning network,” Information Sciences, vol. 177, no. 18, pp. 3764-3781, 2007.
[48] Y.-H. Cheng, J.-Q. Yi, and D.-B. Zhao, “Application of actor-critic learning to adaptive state space construction,” in Proceedings of 2004 International Conference on Machine Learning and Cybernetics (IEEE Cat. No. 04EX826), vol. 5. IEEE, 2004, pp. 2985-2990.
[49] I. C. Paschalidis, K. Li, and R. M. Estanjini, “An actor-critic method using least squares temporal difference learning,” in Proceedings of the 48 h IEEE conference on decision and control (CDC) held jointly with 2009 28th Chinese Control Conference. IEEE, 2009, pp. 2564-2569.
[50] H. R. Berenji and D. Vengerov, “A convergent actor-critic-based frl algorithm with application to power management of wireless transmitters,” IEEE Transactions on Fuzzy Systems, vol. 11, no. 4, pp. 478-485, 2003.
[51] V. R. Konda and J. N. Tsitsiklis, “Onactorcritic algorithms,” SIAM journal on Control and Optimization, vol. 42, no. 4, pp. 1143-1166, 2003.
[52] H. Kimura, “Natural gradient actor-critic algorithms using random rectangular coarse coding,” in 2008 SICE Annual Conference. IEEE, 2008, pp. 2027-2034.
[53] S. Girgin and P. Preux, “Basis expansion in natural actor critic methods,” in European Workshop on Reinforcement Learning. Springer, 2008, pp. 110-123.
[54] J. Park, J. Kim, and D. Kang, “An rls-based natural actor-critic algorithm for locomotion of a two-linked robot arm,” in International Conference on Computational and Information Science. Springer, 2005, pp. 65-72.
[55] S. Bhatnagar, R. S. Sutton, M. Ghavamzadeh, and M. Lee, “Naturalgradient actor-critic algorithms,” Automatica, 2007.
[56] T. Morimura, E. Uchibe, J. Yoshimoto, and K. Doya, “A generalized natural actor-critic algorithm,” Advances in neural information processing systems, vol. 22, 2009.
[57] C. Szegedy, W. Liu, Y. Jia, P. Sermanet, S. Reed, D. Anguelov, D. Erhan, V. Vanhoucke, and A. Rabinovich, “Going deeper with convolutions,” in Proceedings of the IEEE conference on computer vision and pattern recognition, 2015, pp. 1-9.
[58] B. Widrow, N. K. Gupta, and S. Maitra, “Punish/reward: Learning with a critic in adaptive threshold systems,” IEEE Transactions on Systems, Man, and Cybernetics, no. 5, pp. 455-465, 1973
[59] A. G. Barto, R. S. Sutton, and C. W. Anderson, “Neuronlike adaptive elements that can solve difficult leaming control problems,” IEEE transactions on systems, man, and cybernetics, no. 5, pp. 834-846, 1983
[60] M. Nazari, A. Oroojlooy, L. Snyder, and M. Taka'c, “Reinforcement learning for solving the vehicle routing problem,” Advances in neural information processing systems, vol. 31, 2018

1. A method for selecting parts to be placed on sheets using a computer, the method comprising:
I. encoding geometric features of each part in a respective geometric information vector, wherein, for each part, one of the geometric features is a projected area of the part in a plan view; and
II. generating a graph, wherein the geometric features of each part are assigned to one node of the graph, wherein all nodes of the graph are connected in pairs by one edge,
XIV. the method further comprising, in an inference phase: estimating geometrical compatibility indices (GCI) for all pairs of parts, wherein each GCI is a measure of how well the respective pair of parts is capable of being placed on a same sheet;
XV. assigning each GCI to a respective edge of the graph, the respective edge passing through two nodes representing the pair of parts to which the respective GCI is assigned;
XVI. determining weights of the edges of the graph, wherein the respective weight of each respective edge depends on the GCI associated with the respective edge; and
XVII. assigning the parts to a respective sheet by determining subgraphs through the nodes of the graph by an optimization method, wherein the nodes through which a respective subgraph passes represent the parts to be placed on the respective sheet, wherein a sum of the projected areas of the parts on each subgraph is at most equal to a size of the respective sheet.

2. The method according to claim 1, wherein the optimization method in step XVII is performed using a quantum computer.

3. The method according to claim 1, wherein one or more steps of the method are performed by a first neural network.

4. The method according to claim 1, wherein steps XIV, XV and/or XVI are performed by an actor-like module, wherein the actor-like module comprises a first neural network.

5. The method according to claim 1, wherein the assigning the parts to the respective sheet according to step XVII is performed by the optimization method for solving a capacitated vehicle routing problem (CVRP).

6. The method according to claim 1, wherein the sheets have the same size.

7. The method according to claim 1, further comprising, in a training phrase before the inference phase, determining the GCI for all pairs of the parts by:
I. setting estimated values of the GCI, wherein each estimated value of the GCI is assigned to a respective pair of the parts;
II. providing the edges of the graph with first edge weights, wherein each first edge weight depends on the respective GCI assigned to the edge;
III. assigning the parts to a respective sheet by determining subgraphs through the nodes of the graph according to step XVII;
IV. determining a reward function value for each subgraph as a measure of how much of a surface area of the respective sheet is covered by the parts on each subgraph after the parts are nested on the respective sheet;
V. determining a suitability value for each subgraph in a form of an average of output values for the respective subgraph, wherein the output values take into account the estimated values of the GCI, wherein the average is determined by taking into account all the output values for the respective subgraph;
VI. redetermining the GCI on each subgraph such that a reward loss is reduced on each subgraph, wherein the reward loss depends on the reward function value and the suitability value;
VII. repeating steps VI through VIII until the reward loss meets a first termination criterion;
VIII. estimating second edge weights of the edges of the graph, by steps XIV to XVI;
IX. determining edge weight losses at the edges of the graph, wherein the edge weight losses depend on the second edge weights and the GCI determined in step VIII at the respective edges;
X. repeating steps X and XI, wherein estimating the second edge weights is performed such that the edge weight losses are minimized until the edge weight losses meet a second termination criterion; and
XI. repeating steps III through XII, wherein the estimated values of the GCI in step III are set to be the second edge weights last determined in step XII until the estimated values of the GCI meet a third termination criterion.

8. The method according to claim 4, wherein steps X, XI and/or XII are performed by the actor-like module.

9. The method according to claim 7, wherein steps III, IV, VII, VIII and/or IX is/are performed by a critic-like module, wherein the critic-like module comprises a second neural network.

10. The method according to claim 9, wherein the critic-like module further comprises a third neural network, wherein the third neural network receives result data of the second neural network.

11. The method according to claim 7, wherein the redetermination of the GCI according to step VIII is performed using error backpropagation to minimize the reward loss for the respective subgraph.

12. The method according to claim 7, wherein the first termination criterion according to step IX is given by the reward loss being smaller than a first default value, and/or the second termination criterion according to step XII is given by the edge weight losses at the edges of the graph being smaller than a second default value, and/or the third termination criterion according to step XIII is given by the estimated values of the GCI changing by less than a third default value after going through steps III to XII.

13. The method of claim 1, wherein the GCI are determined in step XIV using a metaheuristic.

14. The method according to claim 1, wherein the parts are arranged on the sheets and subsequently produced.
